(19) United States
(12) Patent Application Publication
(10) Pub. No.: US 2026/0208698 A1
(43) Pub. Date: Jul. 23, 2026

(54) END CAP ASSEMBLY FOR A WIPER BLADE UNIT

(71) Applicant: VALEO SYSTEMES D'ESSUYAGE, La Verriere (FR)

(72) Inventors: Gowtham ILANTHIRAYAN, La Verriere (FR); Venkadesh MURUGAN, La Verriere (FR); Veeramanikandan GOPAL, La Verriere (FR); Balamurugan LOGAIAN, La Verriere (FR)

(73) Assignee: VALEO SYSTEMES D'ESSUYAGE, La Verriere (FR)

(21) Appl. No.: 19/134,834

(22) PCT Filed: Dec. 14, 2023
(86) PCT No.: PCT/IN2023/051185

§ 371 Date: Jun. 2, 2025

(30) Foreign Application Priority Data
Dec. 14, 2022 (IN) 202241072241

(51) Int. Cl. B60S 1/38

(52) U.S. Cl. CPC B60S 1/3891; B60S 1/381

(57) ABSTRACT

The present invention is related to an end cap for a wiper blade unit. The wiper blade unit includes a pair of splines and a wiping element. The end cap assembly is configured to be installed at a longitudinal end of the wiper blade unit, and includes a fixed portion configured to be fixedly assembled to the longitudinal end. The fixed portion is configured to prevent a transversal movement of the pair of splines. Further, the end cap assembly includes a removable portion configured to be detachably coupled to the fixed portion, and the removable portion is configured to prevent a longitudinal movement of the wiping element.

### TECHNICAL FIELD

The present invention relates to an end cap assembly adapted to replace a wiping element of a wiper blade unit, and to a vehicle wiper system having the wiper blade unit, and to a method for replacing the wiping element of the wiper blade unit.

### BACKGROUND OF THE INVENTION

Motor vehicles are conventionally equipped with a windscreen wiper system to ensure that the windscreen is washed and that the driver's view of his environment is not disturbed. The windscreen wiper system usually consists of a wiper blade unit and a wiper arm coupled to the wiper blade unit. The wiper blade unit comprises at least a wiping element which directly contacts the windshield of a motor vehicle. The wiper blade unit further comprises a support frame, at least one spline received inside the support frame, a spoiler, and a coupling element for coupling the wiper blade unit to the wiper arm. In order to fasten the wiping element to the support frame, the wiper blade unit further comprises a pair of end caps mounted on longitudinal ends of the support frame. When the wiping element is worn, it has to be replaced with another wiping element. Further, to perform maintenance or repair to the wiper system, it may be required to remove the wiping element from the wiper blade unit. Conventionally, the wiping element is replaced by changing the entire wiper blade unit. This would results in large amount of waste due to the support frame, the coupling element, and the spline being discarded. Some of the conventional end caps are assembled to the support frame by permanent fastening, for example, by crimping. Such assembly does not make it possible to dismount the wiping element from the wiper blade unit and it thus necessary to discard the entire wiper blade unit when the wiping element is worn.

### SUMMARY OF THE INVENTION

An object of the present invention is to alleviate the problems raised above. To be more precise, an object of the present invention is to provide an end cap assembly that makes it possible to replace a wiping element of a wiper blade unit.

[Another object of the present invention is to provide an end cap assembly, which can arrest the movement of splines of the wiper blade unit during the replacement of the wiping element.

To achieve these objectives, the present invention provides an end cap assembly for a wiper blade unit that comprises a pair of splines and a wiping element. The end cap assembly is configured to be installed at a longitudinal end of the wiper blade unit, which extends along a longitudinal axis. The end cap assembly comprises: a fixed portion configured to be fixedly assembled to the longitudinal end, wherein the fixed portion is configured to prevent a transversal movement of the pair of splines; and a removable portion is configured to be detachably coupled to the fixed portion, wherein the removable portion is configured to prevent a longitudinal movement of the wiping element. Advantageously, the end cap assembly of the present invention makes it possible to replace a single component, i.e., the wiping element from the wiper blade unit, rather than replacing the entire wiper blade unit.

According to one characteristic of the present invention, the fixed portion comprises a pair of spline retaining portions, and wherein the pair of splines are configured to abut the pair of spline retaining portions.

According to one characteristic of the present invention, the pair of spline retaining portions comprises a locking portion configured to cooperate with the pair of splines for locking the pair of splines in position with respect to the fixed portion to prevent the transversal movement of the pair of splines towards each other. Advantageously, the fixed portion allows the free movement of the wiping element in a gap between the pair of splines and facilitates to correctly position the wiping element in the wiper blade unit by preventing the transversal movement of the pair of splines.

According to one characteristic of the present invention, at least a portion of an inner surface of the fixed portion is configured to abut a distal end portion of a spoiler of the wiper blade unit

According to one characteristic of the present invention, the removable portion includes an abutment portion configured to abut against a tip portion of the wiping element to prevent the longitudinal movement of the wiping element.

According to one characteristic of the present invention, an upper wall of the removable portion is configured to be flushed with an upper wall of the fixed portion when the removable portion is coupled to the fixed portion.

According to one characteristic of the present invention, an outer edge of the fixed portion that is facing the longitudinal end is configured to abut an outer edge of an open end of the removable portion when the removable portion is coupled to the fixed portion.

According to one characteristic of the present invention, the fixed portion and the removable portion are coupled to one another by a snap-on connection or a press fit connection.

According to one characteristic of the present invention, the removable portion includes a securing means configure to cooperate with the pair of splines to couple the removable portion and the fixed portion.

According to one characteristic of the present invention, the present invention also relates to a wiper blade unit for a motor vehicle, comprising: a wiping element extending along a longitudinal axis and adapted to contact a surface to be wiped; a support member having a pair of splines configured to support the wiping element; a spoiler extending along the longitudinal axis, wherein the spoiler is operatively mounted to the support member; an end cap assembly as has just been presented is configured to be installed at a first longitudinal end of the support member; and a second end cap configured to be installed at a second longitudinal end opposite to the first longitudinal end of the support member.

According to one characteristic of the present invention, the present invention also relates to a method for replacing a wiping element of a wiper blade unit, the method comprising the steps of: detaching a removable portion of an end cap assembly as has just been presented; replacing the wiping element with an another wiping element through the fixed portion; and detachably coupling the removable portion to the fixed portion.

According to one characteristic of the present invention, the step of replacing comprises: dismounting the wiping element from the wiper blade unit, wherein the dismounting comprises longitudinally sliding the wiping element outwardly by holding a tip of the wiping element that is extending out of the fixed portion; and installing another wiping element through the fixed portion by longitudinally sliding it in a gap between a pair of splines of the wiper blade unit.

According to one characteristic of the present invention, the method further comprises preventing a transversal movement of the pair of splines during the replacing of the wiping element.

Further advantages, features and details of the invention will be apparent from the following description of preferred embodiments of the invention and from the drawings.

### BRIEF DESCRIPTION OF DRAWINGS

To complete the description and to provide a better understanding of the invention, a set of drawings is provided. Said drawings form an integral part of the description and illustrate an embodiment of the invention, which should not be construed as restricting the scope of the invention, but only as an example of how the invention can be carried out. The drawings comprise the following characteristics.

FIG. 1 shows a perspective view of a wiper blade unit, according to an embodiment of the present invention.

FIG. 2 shows an exploded view of the wiper blade unit shown in the FIG. 1.

FIG. 3a shows a perspective view of a wiping element of the wiper blade unit shown in the FIG. 1.

FIG. 3b shows a perspective view of a pair of splines of the wiper blade unit shown in the FIG. 1.

FIG. 3c shows a perspective view of a spoiler of the wiper blade unit shown in the FIG. 1.

FIG. 4a shows a portion of a wiper blade unit of the FIG. 1, without an end cap assembly, according to an embodiment of the present invention.

FIG. 4b shows a portion of a wiper blade unit of the FIG. 1, installed with a fixed portion of an end cap assembly, according to an embodiment of the present invention.

FIG. 5a shows a perspective view of a fixed portion of an end cap assembly, according to an exemplary embodiment of the present invention.

FIG. 5b shows a bottom view of the fixed portion shown in the FIG. 5a.

FIG. 5c shows a bottom view of a fixed portion of an end cap assembly, according to another exemplary embodiment of the present invention.

FIG. 5d shows a bottom view of a fixed portion of an end cap assembly, according to another exemplary embodiment of the present invention.

FIG. 6a shows a perspective view of a removable portion of an end cap assembly, according to an exemplary embodiment of the present invention.

FIG. 6b shows a bottom view of the removable portion shown in the FIG. 6a.

FIG. 6c shows a bottom view of a removable portion of an end cap assembly, according to another exemplary embodiment of the present invention.

FIG. 6d shows a bottom view of a removable portion of an end cap assembly, according to another exemplary embodiment of the present invention.

FIG. 6e shows a bottom view of a removable portion of an end cap assembly, according to another exemplary embodiment of the present invention.

FIG. 7a shows a perspective view of a portion of a wiper blade unit with a spoiler and an end cap assembly during installation, according to a first embodiment of the present invention.

FIG. 7b shows a bottom view of the FIG. 7a.

FIG. 7c shows a bottom view of a portion of the wiper blade unit when the end cap assembly is assembled to the wiper blade unit, according to a first embodiment of the present invention.

FIG. 8a shows a perspective view of a portion of a wiper blade unit with a spoiler and an end cap assembly during installation, according to a second embodiment of the present invention.

FIG. 8b shows a bottom view of the FIG. 8a.

FIG. 8c shows a bottom view of a portion of the wiper blade unit when the end cap assembly is assembled to the wiper blade unit, according to a second embodiment of the present invention.

FIG. 9a shows a perspective view of a wiper blade unit with a spoiler and an end cap assembly during installation, according to a third embodiment of the present invention.

FIG. 9b shows a bottom view of the FIG. 9a.

FIG. 9c shows a bottom view of a portion of the wiper blade unit when the end cap assembly is assembled to the wiper blade unit, according to a third embodiment of the present invention.

FIG. 10a shows a perspective view of a portion of a wiper blade unit with a spoiler and an end cap assembly during installation, according to a fourth embodiment of the present invention.

FIG. 10b shows a bottom view of the FIG. 10a.

FIG. 10c shows a bottom view of a portion of the wiper blade unit when the end cap assembly is assembled to the wiper blade unit, according to a fourth embodiment of the present invention.

FIG. 11a shows a perspective view of a portion of a wiper blade unit with a spoiler and an end cap assembly during installation, according to a fifth embodiment of the present invention.

FIG. 11b shows a bottom view of the FIG. 11a.

FIG. 11c shows a bottom view of a portion of the wiper blade unit when the end cap assembly is assembled to the wiper blade unit, according to a fifth embodiment of the present invention.

### DETAILED DESCRIPTION OF THE INVENTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

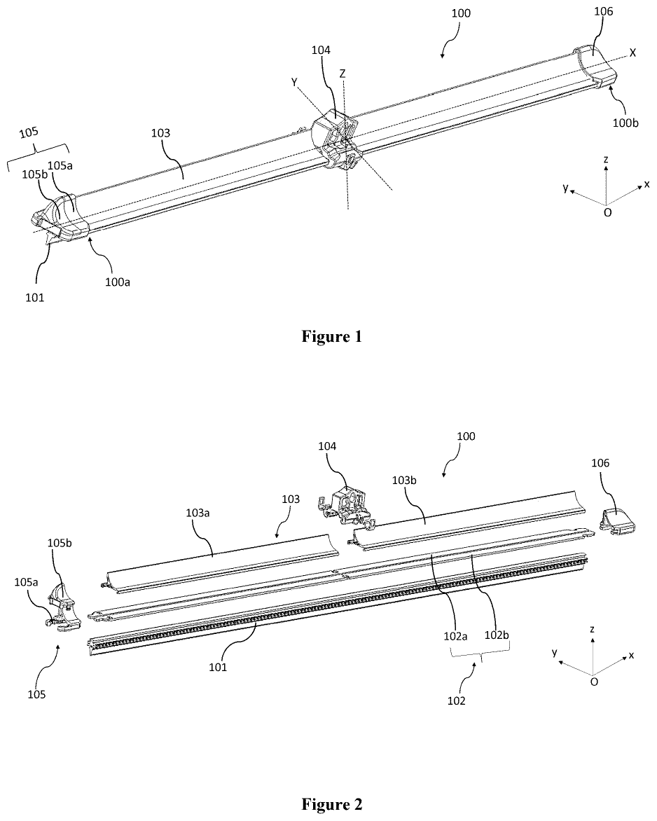

In the figures, the terms longitudinal, transverse, vertical, lateral, left-hand, right-hand, upper, lower refer to the orientation in an orthonormal system of axes Oxyz of a wiper blade unit 100 shown in FIG. 1. In that system of axes, the axis Ox represents the longitudinal direction, the axis Oy represents the transverse direction, and the axis Oz represents the vertical direction of the object concerned, in particular the end cap or the wiper blade unit. In this system of axes, a vertical longitudinal plane is parallel to the plane Oxz, a vertical transverse plane is parallel to the plane Oyz and a horizontal longitudinal plane is parallel to a plane Oxy.

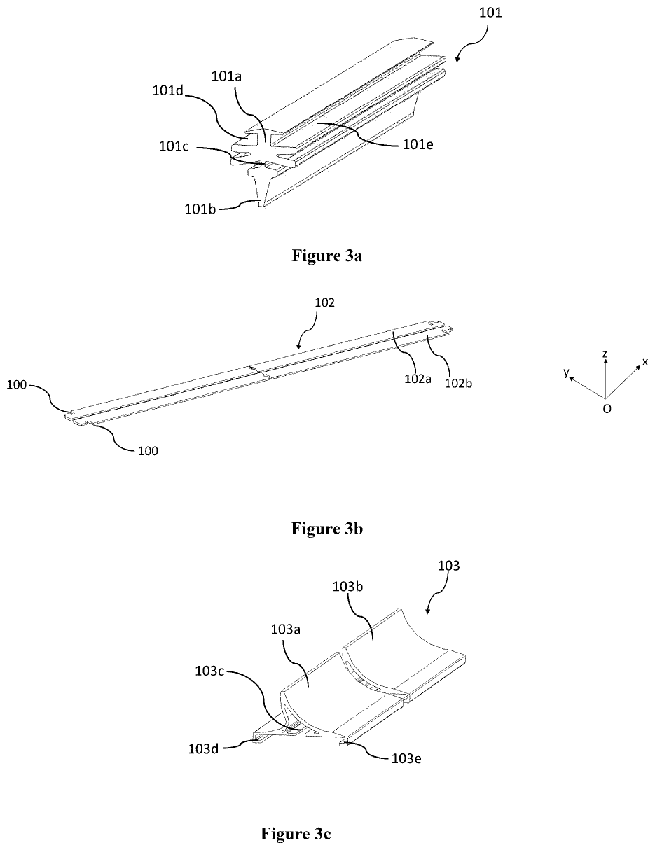

FIG. 1 shows a perspective view of a wiper blade unit, according to an embodiment of the present invention. FIG. 2 shows an exploded view of the wiper blade unit shown in the FIG. 1. FIG. 3a shows a perspective view of a wiping element of the wiper blade unit shown in the FIG. 1. FIG. 3b shows a perspective view of a pair of splines of the wiper blade unit shown in the FIG. 1. FIG. 3c shows a perspective view of a spoiler of the wiper blade unit shown in the FIG. 1.

Referring to the FIG. 1 and the FIG. 2, a wiper blade unit 100 according to the present invention extends along a longitudinal axis X parallel to the axis Ox. The terms left and right relate to a position along a transverse axis Y parallel to the axis Oy on either side of the longitudinal axis X. A vertical axis Z symbolizes a vertical direction parallel to that of the axis Oz that is perpendicular to the longitudinal and transverse directions described hereinabove. The terms upper, and lower or below refer to orientations along the vertical axis Z, the term lower containing the plane of the windshield.

A motor vehicle is generally equipped with a wiper system (not shown in Figures) for evacuating water and/or dirt present on a glazed surface, in particular a rear window or a windshield at the front of a motor vehicle. The wiper system includes a driving arm that is able to effect an angular to-and-fro movement along and over the glazed surface. It will be understood that the present invention is not limited for use solely in connection with wiper systems adapted for use on a vehicle's windshield, but for use in all applications where wiper systems are employed.

The wiper system includes the wiper blade unit 100 that extends along a longitudinal axis X. For example, the wiper blade unit 100 is of a flat blade type. The wiper blade unit 100 comprises a wiping element 101 that also extends along the longitudinal axis X, and the wiping element 101 is adapted to contact a surface of the vehicle to be wiped, for example, the windshield. The wiper blade unit 100 also comprises a support member 102 (shown in FIG. 2 and FIG. 3b) that also extends along the longitudinal axisX and that acts to reinforce or support the wiping element 101. The support member 102 comprises a pair of splines 102a, 102b (shown in FIG. 2 and FIG. 3b). The wiper blade unit 100 may also include a spoiler 103 to prevent the wiper blade unit 100 from lifting from the surface of the windshield. Further, the wiper blade unit 100 also comprises a coupler assembly 104, which is adapted to connect the wiper blade unit 100 to the wiper arm via various types of adaptors/attachment members (not shown, but generally known in the art).

In an embodiment, the wiper blade unit 100 may further include an end cap assembly 105, which is configured to be installed at a first longitudinal end 100a of the wiper blade unit and a second end cap 106, which is configured to be installed at a second longitudinal end 100b opposite to the first longitudinal end 100a of the wiper blade unit 100. The second end cap 106 that is configured to be installed at the second longitudinal end 100b of the wiper blade unit 100 may be similar to the conventional end cap known to a person skilled in the art.

In another embodiment, the end cap assembly 105 may be installed at both the first longitudinal end 100a and the second longitudinal end 100b of the wiper blade unit 100.

The end cap assembly 105 is formed by detachably coupling a fixed portion 105a and a removable portion 105b. The fixed portion 105a and the removable portion 105b are configured to facilitate replacement of the wiping element 101 from the wiper blade unit 100. Further, the fixed portion 105a is configured to prevent the longitudinal movement of the spoiler 103 during the replacement of the wiping element 101. Each of the above components will be described in greater detail below.

The wiping element 101 is constructed from a flexible rubber. While the wiping element of the present invention is constructed from a flexible rubber, those having ordinary skill in the art will appreciate that it may be constructed from any flexible material, such as silicone or another polymer, without departing from the scope of the present invention. As illustrated in FIG. 3a, the wiping element 101 includes an upper portion 101a and a lower portion 101b that are partitioned by a longitudinally extending bridge or hinge portion 101c. The hinge portion 101c provides flexibility between the upper portion 101a and the lower portion 101b during operational movement of the wiper blade unit 100 across the surface to be wiped. The upper portion 101a includes opposed grooves 101d, 101e extending laterally therein and longitudinally there along between longitudinal ends of the wiping element 101. The grooves 101d, 101e may be configured to receive splines 102a, 102b of the support member 102 and cooperate with the splines 102a, 102b to engage the splines 102a, 102b therein.

The support member 102 may be constructed from a resiliently flexible material, such as spring steel or a polymer, and is adapted to apply force from an intermediate position between its longitudinal ends. More specifically, the support member 102 receives a force from the spring loaded wiper arm at an intermediate position and distributes the force across the span of the support member 102 toward its longitudinal ends. In the embodiment illustrated herein, the support member 102 includes the pair of splines 102a, 102b that operatively reinforce or support the wiping element 101. The support member 102 may have a substantially constant width and a constant thickness throughout the length between its longitudinal ends. The constant width and thickness are adapted to provide high lateral and torsional stiffness to avoid lateral and torsional deflections.

The spoiler 103 may be operatively coupled to the wiping element 101 and the support member 102. The spoiler 103 extends along the length of the wiping element 101 and the support member 102. The spoiler 103 acts to reduce the likelihood of wind buoyancy by allowing air to flow over the wiper blade unit 101 during operational movement across the surface to be wiped. In the embodiment illustrated herein, the spoiler 103 includes a pair of airfoil components 103a, 103b that are operatively mounted to the wiping element 101 and the support member 102 with the coupler assembly 104 extending there between. However, those having ordinary skill in the art will appreciate that the spoiler 103 may be defined by a single unitary component without departing from the scope of the present invention. The end cap assembly 105 and the second end cap 106 are adapted to be disposed adjacent to the distal ends of the airfoil components 103a, 103b. The end cap assembly 105 may include a profile that substantially mimics the contours of the airfoil components 103a, 103b to maintain the wind lift characteristics of the wiper blade unit 100 and to provide an increased aesthetic value.

As illustrated in the FIG. 3c, each airfoil component 103a, 103b includes a longitudinal housing 103c and a guiding structure disposed below the longitudinal housing. The guiding structure includes a pair of guide rails 103d, 103e formed at inner side surfaces of the airfoil component 103a, 103b through which the pair of splines 102a, 102b are introduced into the airfoil components 103a, 103b.

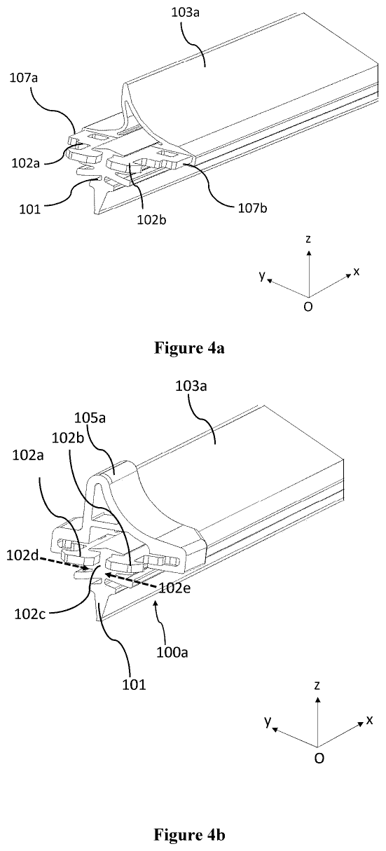

FIG. 4a shows a portion of a wiper blade unit of the FIG. 1, without an end cap assembly, according to an embodiment of the present invention. As can be seen from the FIG. 4a, the pair of splines 102a, 102b are secured inside the pair of guide rails 103d, 103e of the airfoil components 103a, 103b, such that first longitudinal sides 107a, 107b of the pair of splines 102a, 102b abut the inner side surfaces of the airfoil components 103a, 103b, thereby defining a gap between the pair of splines 102a, 102b in the transverse direction. Further, the wiping element 101 is assembled with the pair of splines 102a, 102b in such a way that the splines 102a, 102b are disposed in the grooves 101d, 101e of the wiping element 101. As can be seen from the FIG. 4a, a portion of the pair of splines 102a, 102b and a portion of the wiping element 101 are extended out from a distal end of the first airfoil component 103a (for example) when the wiping element 101, the pair of splines 102a, 102b, and the spoiler 103 are assembled.

FIG. 4b shows a portion of a wiper blade unit of the FIG. 1, installed with a fixed portion of an end cap assembly, according to an embodiment of the present invention. The fixed portion 105a of the end cap assembly 105 is fixedly assembled to the longitudinal end, for example, the first longitudinal end 100a of the wiper blade unit 100. As can be seen from the FIG. 4b, when the fixed portion 105a is coupled to the first longitudinal end 101a of the wiper blade unit 100, a tip portion of the pair of splines 102a, 102b and a tip portion of the wiping element 101 are extended out of the fixed portion 105a. As can be seen from the FIG. 4b, at least a portion of an inner surface of the fixed portion 105a abuts with a distal end portion of the first airfoil component 103a of the spoiler 103 when the fixed portion 105a is fixedly assembled to the wiper blade unit 100.

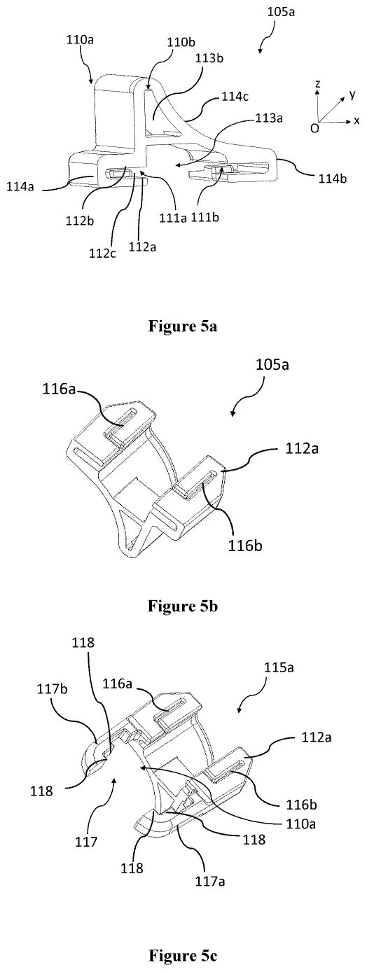

FIG. 5a shows a perspective view of a fixed portion of an end cap assembly, according to an embodiment of the present invention. FIG. 5b shows a bottom view of the fixed portion shown in the FIG. 5a. As can be seen from the FIG. 5a, the fixed portion 105a extends longitudinally between a first end 110a and a second end 110b. The fixed portion 105a comprises a pair of spline retaining portions 111a, 111b and are arranged to face one another along the transverse direction of the fixed portion 105a. Further, the pair of spline retaining portions 111a, 111b extend laterally inwardly from inner surfaces of side walls 114a, 114b and terminating to define a channel 113a between the opposing spline retaining portions 111a, 111b. Further, the fixed portion 105a includes an upper wall 114c, as shown in the FIG. 5a. Each of the spline retaining portion 111a, 111b includes a lower element 112a spaced below an upper element 112b, which also extends laterally inwardly from side walls 114a, 114b, and a retention gap 112c is defined between the upper element 112b and the lower element 112a. The retention gap 112c is configured to be substantially similar in shape to the splines 102a, 102b, which are at least partially disposed therein. The pair of splines 102a, 102b are configured to abut the pair of spline retaining portions 111a, 111b when the pair of splines 102a, 102b are at least partially disposed inside the pair of spline retaining portions 111a, 111b.

The pair of spline retaining portion 111a, 111b are configured to retain the pair of splines 102a, 102b in the longitudinal direction. Further, the fixed portion 105a comprises a housing 113b positioned above the channel 113a in the vertical direction. That is to say, the housing 113b and the channel 113a are being arranged one above the other in the vertical direction (Oz) of the fixed portion 105a. Further, the pair of spline retaining portions 111a, 111b comprises a locking portion configured to cooperate with 25 the pair of splines 102a, 102b for locking the pair of splines 102a, 102b in position with respect to the fixed portion 105a to prevent the transversal movement of the pair of splines 102a, 102b towards each other, i.e., in the direction of in the FIG. 4b illustrated arrows 102d, 102e, so that a gap 102c is maintained between the splines 102a, 102b.

FIG. 5b shows the bottom view of the fixed portion 105a shown in the FIG. 5a. As can be seen from the FIG. 5b, in this exemplary embodiment, the locking portion includes first snap locking elements 116a, 116b arranged on each spline retaining portion 111a, 111b.

FIG. 5c shows a bottom view of a fixed portion of an end cap assembly, according to another exemplary embodiment of the present invention. The fixed portion 115a illustrated in the FIG. 5c differs from the fixed portion 105a illustrated in the FIG. 5b by a pair of legs 117a, 117b that extend longitudinally from the first end 110a and formed in continuity with the side walls 114a, 114b of the fixed portion. Free 10 ends of the legs 117a, 117b may be slightly curved and face each other as can be seen from the FIG. 5c . The fixed portion 115a also includes a void 117 defined between the pair of legs 117a. An outlet of this void 117 is therefore delimited by edges 118. These edges 118 may serve as abutments for the removable portion 105b and the pair of splines 102a, 102b.

FIG. 5d shows a bottom view of a fixed portion of an end cap assembly, according to another exemplary embodiment of the present invention. The fixed portion 125a illustrated in the FIG. 5d differs from the fixed portion 105b shown in the FIG. 5b by the locking portion. As can be seen from the FIG. 5d, the lower element 112a of each spline retaining portion 111a, 111b has one or more cut-out portions 119 defined as the locking portion to lock the pair of splines 102a, 102b with the fixed portion 125a.

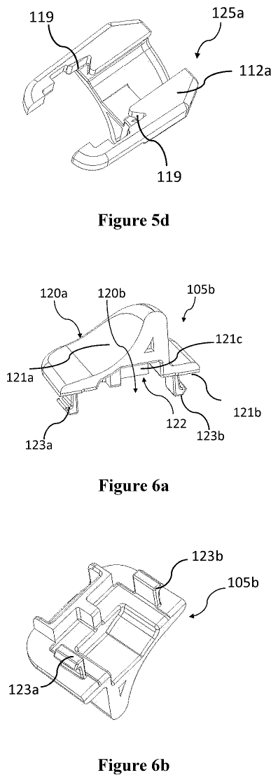

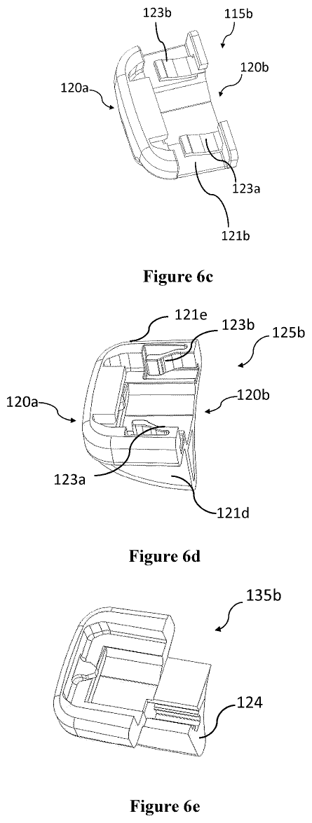

FIG. 6a shows a removable portion of an end cap assembly, according to an exemplary embodiment of the present invention. FIG. 6b shows a bottom view of the removable portion shown in the FIG. 6a. As previously discussed, the removable portion 105b is configured to be detachably coupled to the fixed portion 105a. The removable portion 105b extends longitudinally between a close end 120a and an open end 120b opposite to the closed end 120a, which is defined by a rear wall 121c. The removable portion 105b comprises at least an upper wall 121a, a lower wall 121b and the rear wall 121c. Further, the removable portion 105b includes a housing 122 delimited by at least the upper wall 121a, the rear wall 121c and the lower wall 121b. The removable portion 105b further comprises a securing means configure to cooperate with the pair of splines 102a, 102b to detachably couple the removable portion 105b and the fixed portion 105a. In one exemplary embodiment shown in the FIG. 6b, the securing means include second snap locking elements 123a, 123b projecting downwardly from the lower wall 121b of the removable portion 105b, and arranged on both sides of the housing 112 in the transverse direction of the removable portion 105b. According to another exemplary embodiment, the second snap locking elements 123a, 123b may be arranged to extend longitudinally from the open end 120b and in the direction towards the closed end 120a, as can be seen from the FIG. 6c. Further, the second snap locking elements 123a, 123b according to this exemplary embodiment are disposed below the lower wall 121b and are arranged to face the lower wall 121b. According to another exemplary embodiment of the present invention, the second snap locking elements 123a, 123b may be arranged to extend laterally inwardly from side walls 121d, 121e of the removable portion 125b as can be seen from the FIG. 6d. Further, the second snap locking elements 123a, 123b according to this embodiment extend from the open end 120b and in the direction towards the closed end 120a. FIG. 6e shows a bottom view of a removable portion of an end cap assembly, according to another exemplary embodiment of the present invention. According to this exemplary embodiment, the removable portion 135b is provided with a press-fit component 124 as can be seen from the FIG. 6e.

The fixed portion 105a, 115a, 125a, 135a and the the removable portion 105b, 115b, 125b, 135b, 145b may be detachably coupled by a locking means. By way of an example, the locking means may be chosen from a snap-on connection or a press-fit connection. However, it is understood to a person skilled in the art that the locking means can be any other suitable mechanism which can detachably couple the removable portion 105b, 115b, 125b, 135b, 145b and the fixed portion 105a, 115a, 125a, 135a.

In some embodiments, the removable portion 105b, 115b, 125b, 135b, 145b is detachably coupled to the fixed portion 105a, 115a, 125a, 135a in a direction parallel to axis Ox. In some other embodiments, the removable portion 105b, 115b, 125b, 135b, 145b is detachably coupled to the fixed portion 105a, 115a, 125a, 135a in a direction parallel to axis Oz.

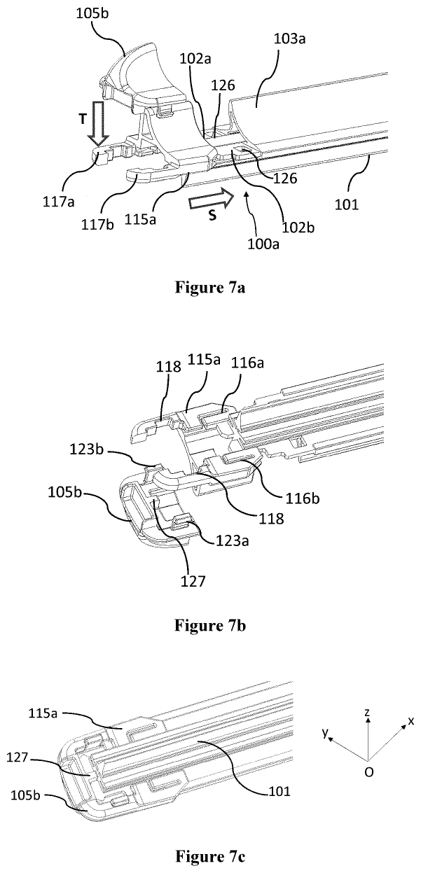

FIG. 7a shows a perspective view of a portion of a wiper blade unit with a spoiler and an end cap assembly during installation, according to a first embodiment of the present invention. FIG. 7b shows a bottom view of the FIG. 7a. In this first embodiment, the fixed portion 115a illustrated in the FIG. 5c is configured to be fixedly assembled to the first longitudinal end 100a of the wiper blade unit 100 and the removable portion 105b illustrated in the FIG. 6a is configured be detachably coupled to the fixed portion 115a.

As shown in this FIG. 7a, a portion of the pair of splines 102a, 102b and a portion of the wiping element 101 extend longitudinally out of the first airfoil component 103a of the spoiler 103. Before mounting the fixed portion 115a, the portions of these elements 102a, 102b, 101 that are extending out are therefore free. As shown in the FIG. 7a, the fixed portion 115a is slid over the first longitudinal end 100a of the wiper blade unit 100 in a direction S parallel to the axis Ox, such that the pair of splines 102a, 102b are received in the pair of spline retaining portions 111a, 111b of the fixed portion 115a. As described previously, the pair of spline retaining portions 111a, 111b are configured to cooperate with the pair of splines 102a, 102b for locking the pair of splines 102a, 102b in position with respect to the fixed portion 115a to prevent the transversal movement of the pair of splines 102a, 102b towards each other. In this embodiment, each spline of the pair of splines 102a, 102b is formed with an aperture 126, which would cooperate with the first snap locking element 116 of each spline retaining portion 111a, 111b when the fixed portion 115a is assembled to the first longitudinal end 100a of the wiper blade unit 100. For instance, the aperture 126 on each spline 102a, 102b is of a rectangular shaped. It is understood that the apertures 126 can be designed in different shapes such that they cooperate with the first snap locking elements 116a, 116b of the pair of spline retaining portions 111a, 111b. For instance, the first snap locking elements 116a, 116b are in the form of protrusions (not shown in the Figures), which are shaped in such a way that the protrusions can be inserted into the apertures 126 so as to lock the fixed portion 115a with the pair of splines 102a, 102b.

When the fixed portion 115a is assembled to the first longitudinal end 100a of 10 the wiper blade unit 100, the tip portion of the pair of splines 102a, 102b and the tip portion of the wiping element 101 extends out of the fixed portion 115a. Further, at least a portion of an inner surface of the fixed portion 115b is configured to abut a distal end portion of the first airfoil component 103a of the spoiler 103 when the fixed portion 115a is assembled to the first longitudinal end 100a of the wiper blade unit 100. Upon the fixed portion 115a is assembled to the first longitudinal end 100a of the wiper blade unit 100, the removable portion 105b is detachably coupled to the fixed portion 115a in the vertical direction, that is to say, in a direction ‘T’ perpendicular to the axis Ox. As can be seem from the FIG. 7a, the removable portion 105b is introduced onto the pair of legs 117a, 117b of the fixed portion 115a in the vertical direction such that hooks of the second snap locking elements 123a, 123b are pressed against a lower face of the pair of legs 118, thereby detachably coupling the removable portion 105b to the fixed portion 105a. FIG. 7c shows a bottom view of a portion of the wiper blade unit when the end cap assembly is assembled at the first longitudinal end of the wiper blade unit, according to the first embodiment of the present invention. When the removable 25 portion 105b is detachably coupled to the fixed portion 115a, the upper wall 121c of the removable portion 105b is flushed with the upper wall 114c of the fixed portion 115a. In other words, the upper wall 121c of the removable portion 105b and the upper wall 114c of the fixed portion 115a extends in a same plane when the removable portion 105b is detachably coupled to the fixed portion 115a. Hence, the end cap assembly 105 is formed with an outer profile that substantially mimics the contours of the airfoil components 103a, 103b, to maintain the wind lift characteristics of the wiper blade unit 100 and to provide an increased aesthetic value. Further, an outer edge of the fixed portion 115a that is facing the first longitudinal end 100a is configured to abut an outer edge of an open end of the removable portion 105b. Furthermore, an abutment portion 127 (shown in FIG. 7c) of the removable portion 105b abuts against the tip portion of the wiping element 101 to prevent the longitudinal movement of the wiping element 101, as can be seen from FIG. 7c, when the removable portion 105b is detachably coupled to the fixed portion 115a. For instance, the abutment portion 127 may be a rib element.

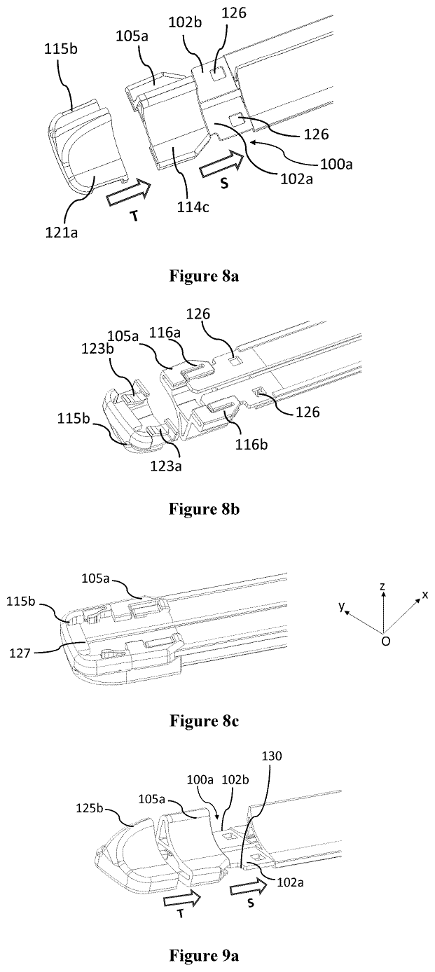

FIG. 8a shows a perspective view of a portion of a wiper blade unit with a spoiler and an end cap assembly during installation, according to a second embodiment of the present invention. FIG. 8b shows a bottom view of the FIG. 8a. In this second embodiment, the fixed portion 105a illustrated in the FIG. 5a is configured to be fixedly assembled to the first longitudinal end 100a of the wiper blade unit 100 and the removable portion 115b illustrated in the FIG. 6c is configured be detachably coupled to the fixed portion 105a.

The second embodiment differs from the first embodiment in the way the removable portion 115b is coupled to the fixed portion 105a. In this second embodiment, the fixed portion 105 is slid over the first longitudinal end 100a of the wiper blade unit 100 in a direction S, which is parallel to the axis Ox such that a portion of the pair of splines 102a, 102b are received inside the pair of spline retaining portions 111a, 111b of the fixed portion 105a. Similar to the first embodiment, in the second 25 embodiment also, the pair of spline retaining portions 111a, 111b are configured to cooperate with the apertures 126 of the pair of splines 102a, 120b for locking the pair of splines 102a, 102b in position with respect to the fixed portion 105a to prevent the transversal movement of the pair of splines 102a, 102b towards each other. Similar to the first embodiment, when the fixed portion 105a is assembled to the first longitudinal end 100a of the wiper blade unit 100, the tip portion of the pair of splines 102a, 102b and the tip portion of the wiping element 101 extends out of the fixed portion 105a. Further, at least a portion of an inner surface of the fixed portion 105a is configured to abut a distal end portion of the first airfoil component 103a of the wiping element 101 when the fixed portion 105a is assembled at the first longitudinal end 100a of the wiper blade unit 100.

In this second embodiment, the removable portion 115b is detachably coupled to the fixed portion 105a by coupling the pair of splines 102a, 102b with the removable portion 115b in the direction ‘T’, which is parallel to the axis Ox. The second snap locking elements 123a, 123b of the removable portion 125b are configured to cooperate with the pair of splines 102a, 102b to couple the removable portion 115b and the fixed portion 105a. The second snap locking elements 123a, 123b of the removable portion 115b cooperates with the tip portion of the splines 102a, 102b that are extending out of the fixed portion 105a to lock the pair of splines 102a, 102b with the removable portion 115b, thereby detachably coupling the fixed portion 105a and the removable portion 115b. FIG. 8c shows a bottom view of a portion of the wiper blade unit when the end cap assembly is assembled at the first longitudinal end of the wiper blade unit, according to the second embodiment of the present invention. When the removable portion 115b is detachably coupled to the fixed portion 105a, the upper wall 121a of the removable portion 115b is flushed with the upper wall 114c of the fixed portion 105a, and an outer edge of the fixed portion 105a that is facing towards the removable end is configured to abut an outer edge of an open end of the removable portion 115b. Further, the abutment portion 127 of the removable portion 115b abut against the tip portion of the wiping element 101 to prevent the longitudinal movement of the wiping element 101, as can be seen from FIG. 8c, when the removable portion 115b is detachably coupled to the fixed portion 105a.

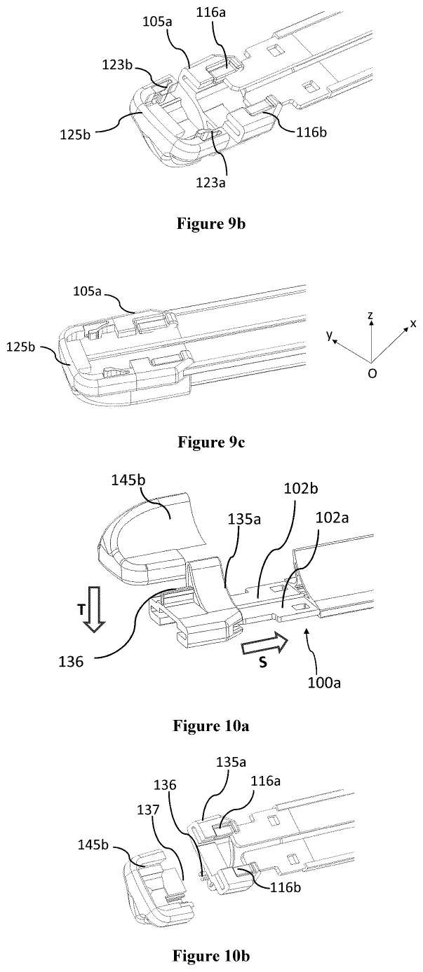

FIG. 9a shows a perspective view of a portion of a wiper blade unit with a spoiler and an end cap assembly during installation, according to a third embodiment of the present invention. FIG. 9b shows a bottom view of the FIG. 9a. In this third embodiment, the fixed portion 105a illustrated in the FIG. 5a is configured to be fixedly assembled to the first longitudinal end 100a of the wiper blade unit 100 and the removable portion 125b illustrated in the FIG. 6d is configured to be detachably coupled to the fixed portion 105a. The assembly of the fixed portion 105a to the first longitudinal end 100a of the wiper blade unit 100 and the assembly of the removable portion 125b to the fixed portion 105a in the third embodiment is same as in the second embodiment. The difference between the third embodiment and the second embodiment is with regards to the arrangement of the second snap locking elements 123a, 123b of the removable portion 125b. In this third embodiment, the removable portion 125b is detachably coupled to the fixed portion 105a by snap locking from the sides of the removable portion 125b. As can be seen from the FIG. 9c, the second snap locking elements 123a, 123b of the removable portion 125b are received in recesses or notches 130 (shown in the FIG. 9a) of the pair of splines 102a, 102b so as to couple the removable portion 125b with the pair of splines 102a, 102b, thereby coupling the removable portion 125b and the fixed portion 105a.

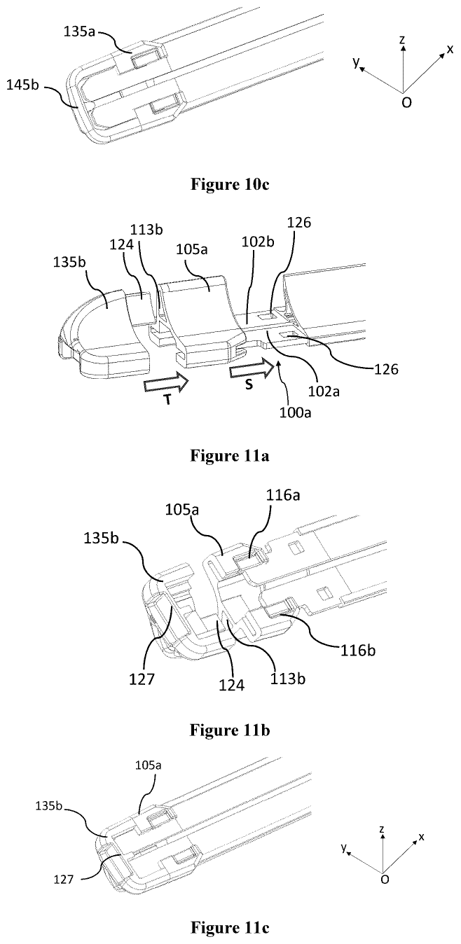

FIG. 10a shows a perspective view of a portion of a wiper blade unit with a spoiler and an end cap assembly during installation, according to a fourth embodiment of the present invention. FIG. 10b shows a bottom view of the FIG. 10a. In this embodiment, a removable portion 145b having a slot 137 (shown in FIG. 10b) is configured to be detachably coupled to a fixed portion 135a having a clip portion 136 (shown in FIG. 10a). Similar to the previous embodiments, the pair of spline retaining portions 111a, 111b are configured to cooperate with apertures 126 of the pair of splines 102a, 102b for locking the pair of splines 102a, 102b in position with respect to the fixed portion 135a to prevent the transversal movement of the pair of splines 102a, 102b towards each other. As shown in the FIG. 10a, the fixed portion 135a is slid over the first longitudinal end 100a of the wiper blade unit 100 in a direction S, which is parallel to the axis Ox such the pair of splines 102a, 102b are locked with the fixed portion 135a. The removable portion 145b is detachably coupled to the fixed portion 135a in the vertical direction, which is in direction T as shown in the FIG. 10a. In this embodiment, the clip portion 136 of the fixed portion 135a is received inside the slot 137 of the removable portion 135a, thereby detachably coupling the fixed portion 135a and the removable portion 145b.

FIG. 11a shows a perspective view of a portion of a wiper blade unit with a spoiler and an end cap assembly during installation, according to a fifth embodiment of the present invention. FIG. 11b shows a bottom view of the FIG. 11a. In this embodiment, the removable portion 135b shown in the FIG. 6e is configured to be detachably coupled to the fixed portion 105a shown in the FIG. 5a by a press-fit connection. Similar to the previous embodiments, the pair of spline retaining portions 111a, 111b are configured to cooperate with apertures 126 of the pair of splines 102a, 102b for locking the pair of splines 102a, 102b in position with respect to the fixed portion 105a to prevent the transversal movement of the pair of splines 102a, 102b towards each other. As shown in the FIG. 11a, the fixed portion 105a is slid over the first longitudinal end 100a of the wiper blade unit 100 in a direction S, which is parallel to the axis Ox such the pair of splines 102a, 102b are locked with the fixed portion 105a. The removable portion 135b is detachably coupled to the fixed portion 105a in the direction T, which is to say along the axis Ox. In this embodiment, a press fit component 124 of the removable portion 135b is introduced inside the housing 113b of the fixed portion 105a, thereby detachably coupling the fixed portion 105a and the removable portion 135b. The press fit component 124 is shaped in such a way that it can be accommodated inside the housing 113b of the fixed portion 105a. Similar to the previous embodiments, the abutment portion 127 of the removable portion 135b abuts against the tip portion of the wiping element to prevent the longitudinal movement of the wiping element 101, as can be seen from FIG. 11c, when the removable portion 135b is detachably coupled to the fixed portion 105a.

According to another embodiment, the present invention relates to a method of assembly of the wiper blade unit 100. The method comprising the steps of: coupling the support member 102 to the coupler assembly 104, which is configured to connect the wiper blade unit 100 and a wiper arm. As mentioned previously, the support member 102 extends along the axis Ox and comprises the pair of splines 102a, 102b. Upon coupling the support member 102 to the coupling assembly 104, the method comprises assembling the spoiler 103 having the pair of airfoil components 103a, 103b with the pair of splines 102a, 102b. The step of assembling comprises guiding the pair of splines 102a, 102b into the pair of guide rails 103d, 103e of the airfoil components 103a, 103b by relatively moving the pair of splines 102a, 102b with respect to the airfoil components 103a, 103b such that such an end portion of the pair of splines 102a, 102b extend longitudinally out from both the airfoil components 103a, 103b from their distal ends. The method further comprises installing a second end cap 106 at a second longitudinal end of the support member 102 such that the end portion of the splines 102a, 102b that are extending out from the distal end of the second airfoil component 103b of the airfoil components 103a, 103b is received inside the second end cap 106. Upon installing the second end cap 106, the fixed portion 105a, 115a, 125a, 135a of the end cap assembly 105 is installed at a first longitudinal end opposite to the second longitudinal end of the support member 102. Once the fixed portion 105a, 115a, 125a, 135a is installed, the wiping element 101 is assembled to the pair of splines 102a, 102b, and the step of assembling comprises guiding the wiping element 101 from its first longitudinal end to a second longitudinal end through a gap between the splines 102a, 102b when the splines 102a, 102b are assembled inside the airfoil components 103a, 103b of the spoiler 103. Next, the method comprises detachably coupling the removable portion 105b, 115b, 125b, 135b, 145b to the fixed portion 105a, 115a, 125a, 135a such that the removable portion 105b, 115b, 125b, 135b, 145b encloses the tip portion of the pair of splines 102a, 102b and the tip portion of the wiping element 101 that are extended out from the fixed portion 105a, 115a, 125a, 135a.

According to another embodiment, the present invention also relates to a method for replacing the wiping element 101 of the wiper blade unit 100. The method comprising the steps of: detaching the removable portion 105b, 115b, 125b, 135b, 145b of the end cap assembly 105, which is installed at a first longitudinal end 100a of the wiper blade unit 100; replacing the wiping element 101 with another wiping element through the fixed portion 105a, 115a, 125a, 135a; and detachably coupling the removable portion 105b, 115b, 125b, 135b, 145b to the fixed portion 105a, 115a, 125a, 135a. The step of replacing comprises: dismounting the wiping element 101 from the wiper blade unit 100, and the dismounting comprises longitudinally sliding the wiping element 101 outwardly by holding the tip of the wiping element 101 that is extending out from the fixed portion 105a, 115a, 125a, 135a; and installing another wiping element through the fixed portion 105a, 115a, 125a, 135a by longitudinally sliding it in the gap between the pair of splines 102a, 102b of the wiper blade unit 100.

As has been described, the end cap assembly 105 of the present invention makes it possible to easy replacement of the wiping element 101 from the wiper blade unit 100. Further, the fixed portion 105a, 115a, 125a, 135a of the end cap assembly 105 would prevent the longitudinal movement of the first airfoil components 103a during the replacement of the wiping element 101. In addition, the fixed portion 105a, 115a, 125a, 135a prevents the movement of the pair of splines 102a, 102b in the transverse direction, thereby allowing the free movement of the wiping element 101 in the gap between the pair of splines 102a, 102b.

According to another embodiment, the present invention is also related to a windscreen wiping system comprising at least the windscreen wiper blade unit 100 shown in the FIG. 1, and a wiper arm to drive the windscreen wiper blade unit 100.

According to another embodiment, the present invention is also related to a motor vehicle comprising the windscreen wiping system.

The person skilled in the art realizes that the present invention by no means is limited to the preferred embodiments described above. On the contrary, many modifications and variations are possible within the scope of the appended claims. In addition, the skilled person readily realizes that the different embodiments described herein may be combined freely to obtain new combinations.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantages.

### LIST OF REFERENCE SIGNS

100 Wiper blade unit
100a First longitudinal end of the wiper blade unit
100b Second longitudinal end of the wiper blade unit
101 Wiping element
101a Upper portion
101b Lower portion
101c Hinge
101d, 101e Opposed grooves
102 Support member
102a Elongated spline
102b Elongated spline
102c Gap between arrows
102d, 102e illustrated arrows
103 Spoiler
103a First air-foil component
103b Second air-foil component
103c longitudinal housing
103d 103e Guiding structures
104 Coupler assembly
105 End cap assembly
105a Fixed portion
105b Removable portion
106 Second end cap
117 Void
117a 117b First longitudinal ends of the pair of splines
110a first end of fixed portion
110b second end of fixed portion
111a, 111b Spline retaining portion
112a lower element of each spline receiving portion
112b upper element of each spline receiving portion
112c Retaining gap
113a Housing of the fixed portion
113b Channel of the fixed portion
114a, 114b sidewalls of the fixed portion.
114c Upper wall of the fixed portion.
115a Fixed portion
125a Fixed portion
116a, 116b First snap locking elements
117a, 117b Pair of legs of the fixed portion
118 Edges of void
119 Cut out portion
120a Closed end of the removable portion
120b Open end of the removable portion
121a Upper wall of the removable portion
121b Lower wall of the removable portion
121c Rear wall of the removable portion
122 Housing of the removable portion
123a, 123b second snap locking elements
115b, 125b, and 135b Removable portions
124 Press fit component
126 apertures on the pair of splines
127 Abutment portion of the removable portion
130 Recessed areas of the pair of splines
135a Fixed portion
145b Removable portion
136 Clip portion of the fixed portion 135a
137 Slot of the removable portion 145b

1. An end cap assembly for a wiper blade unit that includes a pair of splines and a wiping element, wherein the end cap assembly is configured to be installed at a longitudinal end of the wiper blade unit, which extends along a longitudinal axis, the end cap assembly comprising:
a fixed portion configured to be fixedly assembled to the longitudinal end, wherein the fixed portion is configured to prevent a transversal movement of the pair of splines; and
a removable portion configured to be detachably coupled to the fixed portion, wherein the removable portion is configured to prevent a longitudinal movement of the wiping element.

2. The end cap assembly as claimed in claim 1, wherein the fixed portion includes a pair of spline retaining portions, and wherein the pair of splines are configured to abut the pair of spline retaining portions.

3. The end cap assembly as claimed in claim 2, wherein the pair of spline retaining portions include a locking portion configured to cooperate with the pair of splines for locking the pair of splines in position with respect to the fixed portion to prevent the transversal movement of the pair of splines towards each other.

4. The end cap assembly as claimed in claim 1, wherein at least a portion of an inner surface of the fixed portion is configured to abut a distal end portion of a spoiler of the wiper blade unit.

5. The end cap assembly as claimed in claim 1, wherein the removable portion includes an abutment portion configured to abut against a tip portion of the wiping element to prevent the longitudinal movement of the wiping element.

6. The end cap assembly as claimed in claim 1, wherein an upper wall of the removable portion is configured to be flushed with an upper wall of the fixed portion when the removable portion is coupled to the fixed portion.

7. The end cap assembly as claimed in claim 1, wherein an outer edge of the fixed portion that is facing the longitudinal end is configured to abut an outer edge of an open end of the removable portion when the removable portion is coupled to the fixed portion.

8. The end cap assembly as claimed in claim 1, wherein the fixed portion and the removable portion are coupled to one another by a snap-on connection or a press-fit connection.

9. The end cap assembly as claimed in claim 1, wherein the removable portion includes a securing means configure to cooperate with the pair of splines to couple the removable portion and the fixed portion.

10. A wiper blade unit for a motor vehicle, comprising:
a wiping element extending along a longitudinal axis and adapted to contact a surface to be wiped;
a support member having a pair of splines configured to support the wiping element;
a spoiler extending along the longitudinal axis, wherein the spoiler is operatively mounted to the support member;
an end cap assembly configured to be installed at a first longitudinal end of the support member; and
a second end cap configured to be installed at a second longitudinal end opposite to the first longitudinal end of the support member, wherein the end cap includes a fixed portion configured to prevent a transversal movement of the pair of splines, and a removable portion configured to be detachably coupled to the fixed portion, wherein the removable portion is configured to prevent a longitudinal movement of the wiping element.

11. (canceled)

12. (canceled)

13. A method for replacing a wiping element of a wiper blade unit, the method comprising:
detaching a removable portion of an end cap assembly of the wiper blade unit;
replacing the wiping element with an another wiping element through a fixed portion of the end cap assembly; and
detachably coupling the removable portion to the fixed portion.

14. The method as claimed in claim 13, wherein replacing the wiping element includes:
dismounting the wiping element from the wiper blade unit, wherein the dismounting includes longitudinally sliding the wiping element outwardly by holding a tip of the wiping element that is extending out from the fixed portion; and
installing another wiping element through the fixed portion by longitudinally sliding the another wiping element in a gap between a pair of splines of the wiper blade unit.

15. The method as claimed in claim 13, wherein further comprising preventing a transversal movement of the pair of splines during the replacing of the wiping element.
